(19) United States
(12) Patent Application Publication
(10) Pub. No.: US 2024/0255335 A1
(43) Pub. Date: Aug. 1, 2024

(54) GAS STORAGE LEDGER SYSTEM

(71) Applicant: Abu Dhabi National Oil Company, Abu Dhabi (AE)

(72) Inventor: Thierry LUCIDARME, Abu Dhabi (AE)

(73) Assignee: Abu Dhabi National Oil Company, Abu Dhabi (AE)

(21) Appl. No.: 18/562,461

(22) PCT Filed: Oct. 14, 2021
(86) PCT No.: PCT/IB2021/059443

§ 371 Date: Nov. 20, 2023

(51) Int. Cl. G01F 15/06; G06Q 30/0283

(52) U.S. Cl. CPC G01F 15/068; G06Q 30/0283

(57) ABSTRACT

A gas storage ledger system comprises a gas smart meter, capable of measuring on-site a quantity of gas to be stored in an underground reservoir and of providing gas quantity data corresponding to the quantity of gas measured; and a calculation means, coupled to the gas smart meter, capable of receiving the gas quantity data provided by the smart meter and of automatically attaching the gas quantity data to the gas ledger in an authenticated immutable manner. Further, a method for maintaining a gas storage leger is claimed.

### 1. FIELD OF THE INVENTION

The invention relates to a gas storage ledger system used for storing of gas, preferably CO₂ or H₂, in underground reservoirs. The gas storage ledger system improves and certifies gas storage in a secure and reliable manner.

### 2. PRIOR ART

Carbon dioxide (CO₂) emissions are presently considered as one of the main drivers of the climate change. Thus, presently technologies are developed to capture CO₂ out of the environment and from flu gases and to store CO₂ safely within adequately selected geological formations. Such technology is presently tested in some regions at industry scale.

A similar technology could be used for storing H₂ underground. Storing H₂ would allow to store large quantities in some places in the world to manage the huge need of this type of energy in a next future.

Whereas it is intended that the CO₂ maintains in the underground reservoir forever, the H₂ will be retrievable and either given back to the producer or put into the market again.

Hydrocarbon producers have access to expelled underground hydrocarbon geological formations that can be used as underground reservoir volumes for safely storing captured CO₂ or H₂. From the geological point of view the principal factors, which must be analyzed are: geological, geo-thermical and hydrogeological conditions. The geological structure must fulfill several conditions like: depth, volume, thickness of isolating overburden, tightness of the reservoir, permeability and porosity of the rocks, which determine its storage capacity for CO₂ or H₂, hydro-geological connections and many others.
awarded with CO₂ certificates that can be traded among CO₂ emitting industries.

However, as the CO₂ or H₂ storing is done at dedicated sites of the world to which not everyone has easily access, it has to be ensured that the correct quantity of gas is actually stored within the appropriate reservoir.

Safety criteria for underground CO₂ or H₂ storage cover also detailed recognition of potential geological structure with the aspect of identification its eventual ways of escape. It can be caused by the leak of overburden layers, occurrence of cracks and fracture systems and faulting zones as well as by existing potable water intakes or completed oil or gas wells. CO₂ or H₂ leakages from its underground storage reservoirs may also happen through the leakiness in the injection and monitoring wells, as well as due to occurrence other circumstances.

Further, underground reservoirs, such as porous geological formations, have a limited capacity that has to be securely monitored such that no overfilling appears which also may lead to a leakage of CO₂ or H₂.

Therefore, it is an object of the present invention to provide a system that enables secure and reliable certification, tracking and scheduling of underground gas storing, particularly storing of captured CO₂ and H₂ in underground natural reservoirs.

### 3. SUMMARY OF THE INVENTION

The above-mentioned problems are solved by a gas storage ledger system according to claim 1 and a method for maintaining a gas storage ledger of according to claim 11.

Preferably the above-mentioned problems are solved by a gas storage ledger system, comprising a gas smart meter, capable to measure on-site a quantity of gas to be stored in an underground reservoir and to provide gas amount data corresponding to the quantity of gas measured; and a calculation means, coupled to the gas smart meter, capable to receive the gas quantity data provided by the smart meter and to attach the gas quantity data to a gas ledger in an authenticated immutable manner.
underground reservoir there is a correct data basis for the certification of the gas storage. The generated gas amount data are provided to a calculation means that automatically attaches at least the gas quantity data to a gas (storage) ledger. The gas ledger can for example be provided for the respective underground reservoir, a group of reservoirs at a specific site, a particular gas storage provider or for a particular gas storage customer and can store all relevant data needed for a certification of the gas storage and other technical or geological data of the reservoir or site in a secure and manipulation proof manner. Since there is preferably a direct data connection of the gas smart meter to the calculation means and the calculation means automatically receives and attaches the gas data to the electronic gas ledger, the possibility to manipulation of the data can be excluded. As calculation means any type of data processor, computer or cloud computing system can be used. However, for certification purposes a dedicated computer or processor is preferred that can be specially certified or secured against manipulation or attacks. Since the calculation means automatically attaches the gas quantity data to a gas ledger in an authenticated immutable manner reliability and data integrity of the gas ledger is ensured. To do so the calculation means can use authentication, ciphering, encryption or other data security or data certification algorithms that ensure data integrity.

Preferably, the calculation means is capable to maintain the gas ledger is maintained as a smart contract. Therefore, no external authority or organization is necessary to supervise or organize gas storing tasks, particularly CO₂ or H₂ storing tasks, and their documentation and certification. Further, correct an automated documentation reduces risk regarding overfilling and other impropriate use of underground reservoirs. The smart contract may be public or non-public.

Preferably, the calculation means is capable to maintain the smart contract of the gas ledger as a gas ledger blockchain. A blockchain is one possibility to maintain the gas ledger consistent, reliable, manipulation proof and even public, preferably along the complete lifetime of the underground reservoir or the existence of a gas storage provider or customer.

encrypting the gas quantity data into encrypted gas quantity data. Due to data encryption of gas quantity data it is ensured that correct gas quantity data is transmitted from the gas smart meter to the calculation means. Thus, if necessary, the gas quantity data might be transmitted via data connections that have not the highest security levels, i.e. wireless data connections.

Preferably, the calculation means comprises a data decryption means, at least for decrypting the encrypted gas quantity data. If encrypted gas quantity data is provided by the gas smart meter the data encryption means can de-crypt the gas quantity data for further processing.

Preferably, the calculation means is structurally integrated with the gas smart meter. By such a structural integration the security and integrity of the gas ledger smart contract is further improved. Preferably, a “black box” comprising the gas smart meter and the calculation means can be provided that can be officially certified as one single component of the gas storage facility. This officially certified black box can then be used on-site to measure the quantity of gas stored underground and simultaneously and automatically updates the smart contract of the gas ledger with the actually stored gas quantity and associated technical and organizational data.

Preferably, the gas smart meter comprises one or more sensors for measuring and providing information about a volume of gas flowing through the gas smart meter; and/or a pressure of gas flowing through the gas smart meter; and/or a temperature of gas flowing through the gas smart meter; and/or a phase distribution of gas flowing through the gas smart meter. By means of theses sensors the quantity of gas stored can be exactly measured. Since the gas is stored under high pressure it will be liquid in phase but may also contain gaseous contents, i.e. gas bubbles. Thus, the quantity of gas stored depends on volume, pressure, temperature and phase distribution. Preferably, the gas smart meter can measure all of these properties of the gas injected into the underground storage.

Preferably, the gas smart meter and/or the calculation means is capable to calculate a standardized gas quantity data from the information measured by the sensors. From calculated. Such standardized gas quantity can be a standardized volume or weight of gas that is determined referring to a standardized temperature, pressure and phase of the gas. Thus, the stored gas can be compared to other stored gas volumes worldwide.

Preferably the gas smart meter and/or the calculation means is provided manipulation proof to be officially verified. It has to be ensured that the gas smart meter and/or the calculation means that automatically measure and automatically document the gas quantity stored cannot be manipulated after official certification. Preferably, electronic security means or data security mechanisms like program encapsulation or encryption are provided for the calculation means to ensure program integrity. Further, preferably mechanical security means, like a manipulation proof housing are provided to ensure that gas smart meter and its sensors cannot be manipulated.

Preferably, the gas ledger comprises one or more of the following information: a standardized amount of gas stored during a respective gas storage session; and/or data identifying an underground reservoir; and/or data identifying a location of an underground reservoir; and/or data describing an available capacity of an underground reservoir; and/or data describing geological properties of an underground reservoir; and/or time and date data of a gas storage session; and/or data identifying a gas storage capacity provider; and/or data identifying a gas storage customer; and/or data identifying the price for the quantity of gas stored during a respective session; and/or data identifying the price a gas storage customer offers for a quantity of gas to be stored; and/or data identifying the price a gas storage provider offers for a quantity of gas to be stored; and/or the type of the gas; and/or the origin of the gas. The type of gas may comprise CO₂ and H₂, but also other gases to be stored in a certified manner. The origin of the gas may for example identify and differentiate “green H₂”, made from water and environmental energy, or “gray H₂”, made from fossil fuels or coal. The origin different H₂ gases should be stored in different underground reservoirs to have them separated for further use in different markets.

Preferably, the calculation means further comprising a scheduling means capable of analyzing data from the gas ledger and providing a scheduling plan for gas storage sessions. Depending on the available void volume of the underground reservoir and scheduling means can automatically calculate a schedule for future gas storage sessions. This can done for one injection site, a plurality of injection sites, one underground reservoir, a group of underground reservoirs or even all underground reservoirs of a gas storage provider. Thus, the technically, environmentally and economically best schedule for gas storage is calculated by the scheduling means.

Preferably, the above-mentioned problems are also solved by a method for maintaining a gas storage ledger, the method comprising the following steps:
a. measuring on-site by means of gas smart meter a quantity of gas to be stored in an underground reservoir;
b. providing by means of the gas smart meter gas quantity data corresponding to the quantity of gas measured;
c. receiving the gas quantity data provided by the smart meter by means of a calculation means coupled to the gas smart meter;
d. attaching the gas quantity data by the calculation means to a gas ledger in an authenticated immutable manner.

This method provides the above-mentioned advantages in terms of automatic measurement, data security and automatic certification of gas underground storage. It provides a solution for an automatic and certified generation of a gas (storage) ledger in an authenticated immutable manner, preferably in form of a smart contract like a blockchain, directly from the measured gas quantity without any further input of a user.

Preferably, the method further comprises the steps of:
encrypting by data encryption means of the gas smart meter the gas quantity data into encrypted gas quantity data; and
decrypting by data decryption means of the data calculation means the encrypted gas quantity data.

Preferably, the measuring step comprises by one or more sensors measuring and providing information about: a volume of gas flowing through the gas smart meter; and/or a pressure of gas flowing through the gas smart meter; and/or a temperature of gas flowing through the gas smart meter; and/or a phase distribution of gas flowing through the gas smart meter.

Preferably, the method further comprises the following step:
attaching by the calculation means to the gas ledger one or more of the following information: a standardized amount of gas stored during a respective gas storage session; and/or data identifying an underground reservoir; and/or data identifying a location of an underground reservoir; and/or data describing an available capacity of an underground reservoir; and/or data describing geological properties of an underground reservoir; and/or time and date data of a gas storage session; and/or data identifying a gas storage capacity provider; and/or data identifying a gas storage customer; and/or data identifying the price for the quantity of gas stored during a respective session; and/or data identifying the price a gas storage customer offers for a quantity of gas to be stored; and/or data identifying the price a gas storage provider offers for a quantity of gas to be stored; and/or the type of the gas; and/or the origin of the gas.

Preferably, the method comprises the following steps:
analyzing data from the gas ledger; and
providing a scheduling plan for gas storage sessions by means of a scheduling means.

Preferably, also for the method, the gas is CO₂ or H₂.

### 4. SHORT DESCRIPTION OF THE DRAWINGS

In the following, preferred embodiments of the invention are disclosed by reference to the accompanying FIGURE, in which shows:

FIG. 1 a schematic overview of a gas storage ledger system.

### 5. DETAILED DESCRIPTION OF PREFERRED EMBODIMENTS

In the following, preferred embodiments of the invention are described in detail with respect to the FIGURES.

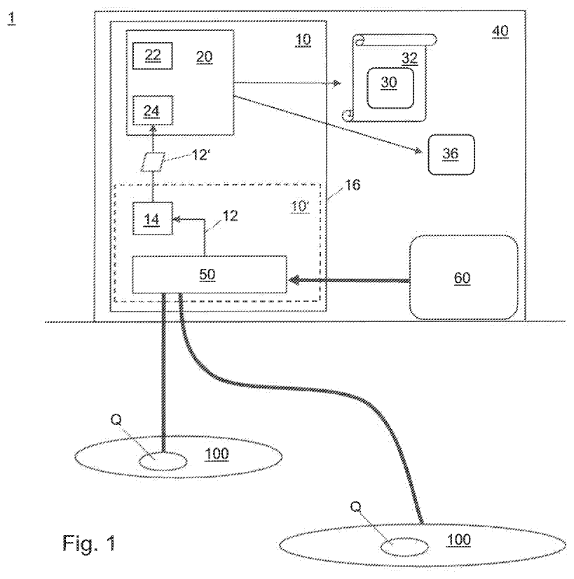

FIG. 1 shows a gas storage ledger system 1 at a gas injection facility 40. The storage ledger system 1 measures and certifies the amounts or quantities Q of gas stored within smart meter 10 a calculation means being coupled to gas smart meter 10.

The gas is preferable CO₂ or H₂ and the gas smart meter 10 is preferably a CO₂ smart meter or a H₂ smart meter.

The gas smart meter 10 is capable to measure on-site a quantity Q of gas to be stored in an underground reservoir 100 and to provide gas quantity data 12 corresponding to the quantity of gas measured.

The gas smart meter 10 comprises one or more sensors 50 for measure on-site a quantity Q of gas to be stored in an underground reservoir 100. From these measurements the gas smart meter calculates gas quantity data and to provides gas quantity data 12 to the calculation means 20.

The sensors 50 preferably measure a volume of gas flowing through the gas smart meter 10, a pressure of gas flowing through the gas smart meter 10, a temperature of gas flowing through the gas smart meter 10 and/or a phase distribution of gas flowing through the gas smart meter 10. Thus, the sensors 50 provide all physical measurement data to calculate the quantity of gas stored within the underground reservoirs 100. Such quantity is calculated by the gas smart meter 10 or the calculation means 20 as a standardized gas quantity, such that the gas quantity can be compared with other gas quantities stored under different injection or environmental conditions.

The smart meter 10 further comprises a data encryption means 14, at least for encrypting the gas quantity data 12 and other data into encrypted gas quantity data 12′. The encrypted gas quantity data 12′ are then transmitted via a corresponding data link to the calculation means 20.

The calculation means 20 can be any kind of processor or computer or cloud computing device. As shown in dashed lines the calculation means 20 may be physically or structurally separate from the smart meter 10′. However, in a preferred embodiment the calculation means 20 is a processor or computer that is structurally integrated with the gas smart meter 10. Therefore, a common housing 16 structurally integrating the housing 16 allows to manipulation proof enclose the gas storage ledger system 1 after official certification.

The calculation means 20 receives gas quantity data 12 provided by the smart meter 10 and automatically attaches the gas quantity data to a gas ledger 30 in an authenticated immutable manner. The gas ledger 30 is contained within an electronic data file, preferably in form of a smart contract 32. Preferably, the smart contract 32 may be a blockchain.

The calculation means 20 can also attach other data to the gas ledger about the gas storage procedure. Preferably the gas ledger 30 comprises all information necessary for the certification of the gas storage, particularly a standardized amount of gas stored during a respective gas storage session.

Other data of the gas ledger 30 can include data identifying an underground reservoir 100, data identifying a location of an underground reservoir 100 data describing an available capacity of an underground reservoir 100, data describing geological properties of an underground reservoir 100, time and date data of a gas storage session.

In addition, the gas ledger may comprise further information relating to the contract between a gas storage provider and gas storage customer. Such data of the gas ledger can include data identifying a gas storage capacity provider, data identifying a gas storage customer, data identifying the price for the quantity of gas stored during a respective session, data identifying the price a gas storage customer offers for a quantity of gas to be stored, data identifying the price a gas storage provider offers for a quantity of gas to be stored. In case of H₂ gas this allows correct retrieval of the H₂ gas for the respective customer when required in the future.

From the data describing an available capacity of an underground reservoir 100 and data describing geological properties of an underground reservoir 100, a risk assessment for the gas storage can be done by the calculation means. For example, the natural rock quality of the underground reservoir 100 assessed by measurements and the purity of the gas maybe a reservoir allocation or load balancing criteria. Further, and might have a toxic effect, have an influence on the reservoir allocation.

Further the gas ledger, may be directly used as smart contract between the gas storage provider and gas storage customer as it can comprise data identifying the price a gas storage customer offers for a quantity of gas to be stored and data identifying the price a gas storage provider offers for a quantity of gas, preferably CO₂ gas, to be stored. Thus, the calculation means 20 using the gas ledger 30 can automatically provide a mechanism for making a transaction for storing a certain quantity of gas and additionally provides automatic certification, preferably CO₂ certification, of that storage.

Such technical and economic data in the gas ledger can be used by as scheduling means 22 of the calculation means 20. The scheduling means 22 analyzes data from the gas ledger 30 and automatically calculates a scheduling plan 36 for specific gas storage sessions according to technical, environmental and economic criteria. Such scheduling plan 36 can be calculated for one specific reservoir 100, a group of reservoirs 100, a specific site or a specific gas storage provider, for example.

The gas ledger 30 further can comprise all past gas storage sessions, the associated transactions of the gas storage customer with the gas storage provider and other historic economical or technical data associated for a specific reservoir 100, a group of reservoirs 100, a specific site or a specific gas storage provider.

1. Gas-A gas storage ledger system, comprising:
a. a gas smart meter, capable to measure on-site a quantity of gas to be stored in an underground reservoir and to provide gas quantity data corresponding to the quantity of gas measured; and
b. a calculation means, coupled to the gas smart meter, capable to receive the gas quantity data provided by the smart meter and to automatically attach the gas quantity data to a gas ledger in an authenticated immutable manner.

2. The gas storage ledger system according to claim 1 wherein the calculation means is capable to maintain the gas ledger as a smart contract.

3. The gas storage ledger system according to claim 2, wherein the calculation means is capable to maintain the smart contract of the gas ledger as a gas ledger blockchain.

4. The storage ledger system according to claim 1, wherein the gas smart meter comprises a data encryption means, at least for encrypting the gas quantity data into encrypted gas quantity data.

5. The gas storage ledger system according to claim 1, wherein the calculation means comprises a data decryption means, at least for decrypting the encrypted gas quantity data.

6. The gas storage ledger system according to claim 1, wherein the calculation means is structurally integrated with the gas smart meter.

7. The gas storage ledger system according to claim 1, wherein the gas smart meter comprises one or more sensors for measuring and providing information about:
a. a volume of gas flowing through the gas smart meter; and/or
b. a pressure of gas flowing through the gas smart meter; and/or
C. a temperature of gas flowing through the gas smart meter; and/or
d. a phase distribution of gas flowing through the gas smart meter.

8. The gas storage ledger system according to claim 7, wherein the gas smart meter and/or the calculation means is capable to calculate a standardized gas quantity data from the information measured by the sensors.

9. The gas storage ledger system according to claim 1, wherein the gas smart meter and/or the calculation means is provided manipulation proof to be officially verified.

10. The gas storage ledger system according to claim 1, wherein the gas ledger comprises one or more of the following information:
a. a standardized amount of gas stored during a respective gas storage session; and/or
b. data identifying an underground reservoir; and/or
C. data identifying a location of an underground reservoir; and/or
d. data describing an available capacity of an underground reservoir; and/or
e. data describing geological properties of an underground reservoir; and/or
f. time and date data of a gas storage session; and/or
g. data identifying a gas storage capacity provider; and/or
h. data identifying a gas storage customer; and/or
i. data identifying the price for the quantity of gas stored during a respective session; and/or
j. data identifying the price a gas storage customer offers for a quantity of gas to be stored; and/or
k. data identifying the price a gas storage provider offers for a quantity of gas to be stored; and/or
l. the type of the gas; and/or
m. the origin of the gas.

11. The gas storage ledger system according to claim 1, wherein the calculation means further comprising a scheduling means capable of analyzing data from the gas ledger and providing a scheduling plan for gas storage sessions.

12. The gas storage ledger system according to claim 1, wherein the gas is CO2 or H2.

13. A method for maintaining a gas storage ledger, the method comprising the following steps:
a. measuring on-site by means of gas smart meter a quantity (Q) of gas to be stored in an underground reservoir;
b. providing by means of the gas smart meter gas quantity data corresponding to the quantity (Q) of gas measured;
C. receiving the gas quantity data provided by the gas smart meter by means of a calculation means coupled to the gas smart meter;
d. automatically attaching the gas quantity data by the calculation means to a gas ledger in an authenticated immutable manner.

14. A method according to claim 13, further comprising the following steps:
encrypting by a data encryption means of the gas smart meter the gas quantity data into encrypted gas quantity data; and
decrypting by a data decryption means of the data calculation means the encrypted gas quantity data.

15. The method according to claim 13, wherein the measuring step comprises by one or more sensors measuring and providing information about:
a. a volume of gas flowing through the gas smart meter; and/or
b. a pressure of gas flowing through the gas smart meter; and/or
C. a temperature of gas flowing through the gas smart meter; and/or
d. a phase distribution of gas flowing through the gas smart meter.

16. The method according to claim 13, further comprising the following step:
attaching by the calculation means to the gas ledger one or more of the following information:
a. a standardized amount of gas stored during a respective gas storage session; and/or
b. data identifying an underground reservoir; and/or
c. data identifying a location of an underground reservoir; and/or
d. data describing an available capacity of an underground reservoir; and/or
e. data describing geological properties of an underground reservoir; and/or
f. time and date data of a gas storage session; and/or
g. data identifying a gas storage capacity provider; and/or
h. data identifying a gas storage customer; and/or
i. data identifying the price for the quantity of gas stored during a respective session; and/or
j. data identifying the price a gas storage customer offers for a quantity of gas to be stored; and/or
k. data identifying the price a gas storage provider offers for a quantity of gas to be stored; and/or
l. the type of gas; and/or
m. the origin of the gas.

17. The method according to claim 13, further comprising the following steps:
analyzing data from the gas ledger; and
providing a scheduling plan for gas storage sessions by means of a scheduling means of the calculation means.

18. The method according to claim 13 wherein the gas is CO2 or H2.
